(19) United States
(12) Patent Application Publication
(10) Pub. No.: US 2004/0191507 A1
(43) Pub. Date: Sep. 30, 2004

(54) Strippable laminate finish

(76) Inventors: Mark D. Levitt, Saint Paul, MN (US); Bryan Michael Anderson, Saint Paul, MN (US); Keith Edward Olson, Apple Valley, MN (US); Kim R. Smith, Woodbury, MN (US)

Correspondence Address: IPLM GROUP, P.A., POST OFFICE BOX 18455, MINNEAPOLIS, MN, 55418, US

(21) Appl. No.: 10/821,595

(22) Filed: Apr. 9, 2004

Related U.S. Application Data
(62) Division of application No. 09/838,884, filed on Apr. 20, 2001.
Application No. 09/838,884 is a continuation-in-part of application No. 09/560,170, filed on Apr. 28, 2000.

(51) Int. Cl. B32B 1/00

(52) U.S. Cl. 428/336; 442/131; 442/76; 442/85

(57) ABSTRACT

A coated substrate comprises a strippable intermediate coating atop the substrate and a strip agent-permeable waterborne overcoat adhered to the intermediate coating, wherein the dried overcoat is less strippable and more wear-resistant than the dried intermediate coating. When the overcoat eventually becomes worn and must be renewed, a strip agent (e.g., chemical strip agent) can be applied to the overcoat. The strip agent penetrates the overcoat and attacks the intermediate coating, thereby enabling removal of the intermediate coating and overcoat without aggressive removal techniques such as sanding.

### CROSS-REFERENCE TO RELATED APPLICATION

This application is a continuation-in-part of application Ser. No. 09/560,170, filed Apr. 28, 2000.

### TECHNICAL FIELD

This invention relates to a strippable laminate finish, a strippable laminate finish kit, and methods for applying and for removing a finish.

### BACKGROUND

UV light curable coating compositions typically provide a desirable combination of properties including rapid cure, high gloss and good durability. Due to these properties and their generally good scratch and detergent resistance, UV light curable coating compositions have been used as floor finishes. Eventually even a UV light cured floor finish will show the effects of wear, and will require removal and renewal. UV cured floor finishes generally are not regarded as being removable using conventional chemical floor stripping agents. Instead, more aggressive removal techniques such as floor sanding or aggressive burnishing may be employed, thereby leading to removal of a portion of the underlying floor surface. This has discouraged the use of UV cured floor finishes.

PCT Published Application No. WO 98/11168 describes radiation curable compositions for use as floor finishes. The compositions are based on polyfunctional isocyanurates and are solvent-borne. The compositions can be applied over an acrylated latex primer layer having at least 1 free-radically polymerizable group pendant from each latex particle (see page 19, lines 12-15), and are said to be strippable when applied over such a primer. When other primers such as TECHNIQUE™ floor finish (commercially available from SC Johnson Professional Products) and TOPLINE™ floor finish (commercially available from 3M) were employed, the measured intercoat adhesion using a crosshatch tape removal test was less than 10% (see Examples 72-80 at pages 35-37).

### SUMMARY OF THE INVENTION

The present invention provides, in one aspect, a coated substrate comprising a strippable intermediate coating atop the substrate and a strip agent-permeable waterborne overcoat adhered to the intermediate coating, wherein the dried overcoat is less strippable and more wear-resistant than the dried intermediate coating. In a preferred embodiment, the substrate comprises a floor, the waterborne strip agent-permeable coating comprises a UV curable coating, the intermediate coating comprises an acrylic, and the strip agent comprises a chemical strip agent containing a phenyl alcohol.

Upon drying (which can occur via loss of water, optionally accompanied by polymerization or other form of curing), the overcoat protects the underlying intermediate coating and substrate from abrasion, dirt, and other environmental effects. When the overcoat eventually becomes worn and must be renewed, a strip agent (e.g., chemical strip agent) can be applied to the overcoat whereupon the strip agent will penetrate the overcoat and attack the underlying intermediate coating. The intermediate coating breaks down due to the action of the strip agent, thereby enabling removal of the intermediate coating and overcoat without the need for the use of aggressive removal techniques such as floor sanding or aggressive burnishing.

In another aspect, the invention provides a strippable laminate finish kit, comprising one or more containers of a strippable intermediate coating and a strip agent-permeable waterborne overcoat, wherein the dried overcoat adheres to the intermediate coating and is less strippable and more wear resistant than the dried intermediate coating. The strippable laminate finish kit optionally includes a strip agent.

In a further aspect, the invention provides a method for applying a finish to a substrate, comprising applying to the substrate a strippable intermediate coating, drying the intermediate coating, and applying a strip agent-permeable waterborne overcoat to the intermediate coating, wherein the dried overcoat adheres to the intermediate coating and is less strippable and more wear resistant than the intermediate coating.

In yet a further aspect, the invention provides a method for removing a multilayer finish, comprising applying a strip agent to a dried waterborne radiation cured overcoat adhered to a dried intermediate layer atop a substrate, allowing the strip agent to permeate through the overcoat to attack the intermediate layer, and removing the intermediate layer and overcoat without removing substantial portions of the underlying substrate.

### BRIEF DESCRIPTION OF THE DRAWING

FIG. 1 shows a view in cross-section of a floor coated with a laminate finish of the invention.

FIG. 2 shows a view in cross-section of a wall coated with a laminate finish of the invention.

FIG. 3 shows a view in cross-section of the application of a chemical strip agent to a laminate finish in the invention.

FIG. 4 shows a view in cross-section illustrating removal of a laminate finish of the invention.

### DETAILED DESCRIPTION

As used in connection with this invention, a coating is regarded as being “strippable” if when subjected to the action of a suitable strip agent, the coating can readily be removed from the substrate using simple, non-abrasive measures such as a mop and detergent solution, or mildly abrasive but substrate-non-damaging measures such as a nonwoven floor scrub pad. Strippability preferably is evaluated using the Second Strippability Evaluation Method (7 point scale) set out below in the Example section, using Test Strip Agent K and a 10 minute strip agent standing time.

As used in connection with this invention, an undried coating material is regarded as being waterborne when the coating material contains more than trace amounts (e.g., more than about 5 wt. %) of water. Preferably, such waterborne coating materials will be emulsions, suspensions, dispersions or solutions in water. We will also use the term waterborne to refer to dried coatings that were waterborne before they were dried.

As used in connection with this invention, an overcoat is regarded as being “adhered” to an intermediate coating when the overcoat exhibits at least 50% adhesion when evaluated using the Gardner Adhesion Test described in Example 4.

As used in connection with this invention, an overcoat is regarded as being “strip agent-permeable” if when coated atop a desired intermediate coating, dried and subjected to the action of a suitable strip agent, the strip-agent permeates or otherwise penetrates the overcoat sufficiently so that both the overcoat and intermediate coating can be removed from the substrate. Strip agent permeability can be enhanced by a mechanically roughening the overcoat (using, for example, a nonwoven floor scrub pad, brush or other mild abrasive measure) just prior to stripping. An overcoat will be regarded as being strip agent-permeable even if such mechanical roughening is required, so long as the required mechanical roughening does not damage the underlying substrate.

As used in connection with this invention, an overcoat is regarded as being more wear resistant than an underlying strippable intermediate coating when the dried overcoat exhibits lower weight loss than the dried intermediate coating using a Taber Abrasion test conducted according to ASTM D4060-95.

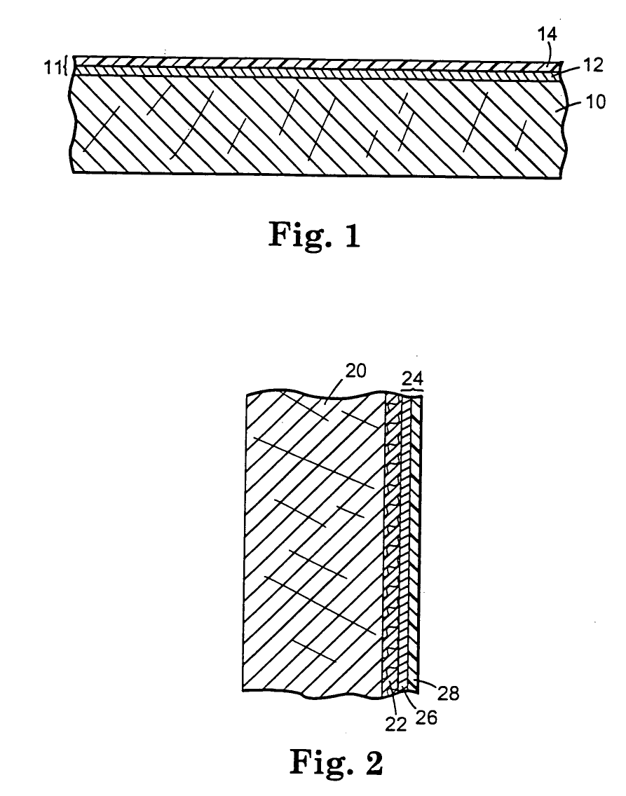

Referring now to FIG. 1, floor 10 is overcoated with laminate finish 11 containing intermediate coating 12 and overcoat 14. Overcoat 14 is a dried waterborne UV-curable floor finish whose wear resistance and durability protect underlying intermediate coating 12 and floor 10 from dirt, scuffing and other environmental factors. If desired, overcoat 14 can be overcoated with one or more layers of other materials (not shown in FIG. 1), such as maintenance coats of additional UV-curable floor finish. Intermediate coating 12 is a dried floor finish (e.g., a metal-catalyzed acrylic finish) having lower wear resistance than overcoat 14. If used alone on floor 10, intermediate coating 12 could readily be stripped from floor 10 using a conventional chemical floor stripping agent. If used alone on floor 10, overcoat 12 would not be strippable (or might only be stripped with difficulty) from floor 10 using such a stripping agent.

FIG. 2 shows a wall 20 overcoated with wallpaper 22 and protective laminate finish 24 containing intermediate coating 26 and overcoat 28. Overcoat 28 is a dried acrylic latex paint whose wear resistance and durability protect underlying intermediate coating 26, wallpaper 22 and wall 20 from scuffing, abrasion and other wear or damage. Intermediate coating 26 is a dried metal-catalyzed acrylic coating having lower wear resistance than overcoat 28. If used alone on wall 20, intermediate coating 22 could readily be stripped from wall 20 using a thickened version of a conventional chemical floor stripping agent. If used alone on wall 20, overcoat 24 would not be strippable (or might only be stripped with difficulty) from wall 20 using such a stripping agent.

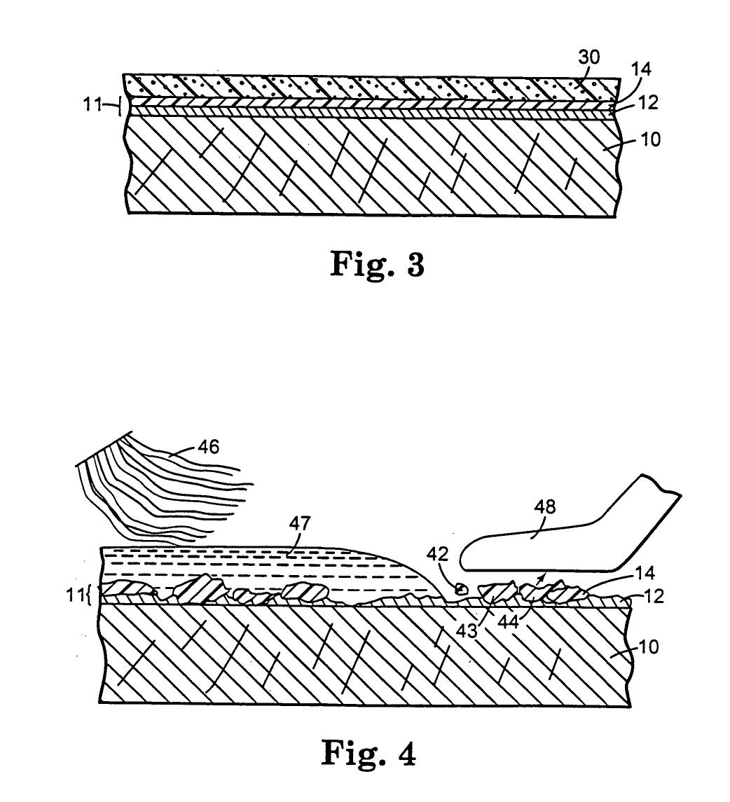

FIG. 3 shows the application of chemical stripping agent 30 to the laminate finish 11 of FIG. 1, and FIG. 4 shows the subsequent removal of the softened laminate finish 11. As shown in FIG. 3, agent 30 permeates and penetrates overcoat 14 but does not significantly soften or otherwise attack overcoat 14. On reaching intermediate coating 12, agent 30 causes intermediate coating 12 to soften and break apart. Intermediate coating 12 loosens its bond with floor 10 and begins a gradual disintegration process (illustrated in FIG. 4) that eventually causes intermediate coating 12 and overcoat 14 to break up into small particles such as particles 42, 43 and 44. By using a mop 46 and water 47, the disintegration process can be accelerated. Vacuum 48 facilitates removal of the residue of the laminate finish 11 from floor 12.

A variety of substrates can be coated with the laminate finishes of the invention. For example, flooring materials that can be coated include resilient materials such as vinyl flooring, vinyl composite flooring, and synthetic sports floors; and non-resilient materials such as concrete, marble and wood. Other substrates that can be coated include walls, ceilings, labels, emblems, indoor and outdoor signs, and vehicles such as automobiles.

A variety of intermediate coating materials can be employed. Suitable intermediate coating materials should be strippable using a strip agent that is capable of permeating the dried overcoat. Thus, the choice of intermediate coating material will be determined in part by the chosen overcoat and stripping agent. Waterborne intermediate coating materials are preferred for ease of application. Water-soluble acrylics are a preferred class of intermediate coating materials. Water-soluble acid-containing polymers crosslinked using transition metals (e.g., metal crosslinked acrylics) are a particularly preferred class. These acid-containing polymers can be stripped using a variety of strip agents (described in more detail below) that dissolve the intermediate coating or attack the crosslinking site. Preferred intermediate coatings will have a rating of 6 or more, more preferably a rating of 7, when coated alone on a vinyl composite tile substrate and evaluated using second Strippability Evaluation Method (7 point scale), using Test Strip Agent K and a 10 minute strip agent standing time. Suitable commercially available intermediate coatings include GEMSTAR LASER™ and TAJ MAHAL™ acrylic finishes from Ecolab Inc.; CORNERSTONE™ and TOPLINE™ floor finishes from 3M; HIGH NOON™ acrylic finish from Butchers; CITATION™ acrylic finish from Buckeye International, Inc.; COMPLETE™, SIGNATURE™, TECHNIQUE™ and VECTRA™ acrylic finishes from SC Johnson Professional Products; SPLENDOR™, DECADE 90™, PRIME SHINE™ ULTRA and PREMIER™ acrylic finishes and FORTRESS™ urethane acrylic finish from Minuteman, International, Inc.; UPPER LIMITS™ acrylic finish from Spartan Chemical Co.; blends of ROSHIELD™ 3120 UV curable acrylated latex from Rohm & Haas with styrene maleic anhydride polymer as described in PCT Published Patent Application No. 98/11168; and materials such as those described in U.S. Pat. Nos. 4,517,330 and 5,319,018 and the patents cited therein. Strippable floor coatings designated as “sealers” (e.g., OVER AND UNDER™ floor sealer, available from S. C. Johnson Professional Products and ACRYL-KOTE™ Seal and Finish and PREP Floor Seal from Minuteman, International, Inc.) and strippable coatings based on polyvinylacetates can also be used. Blends of coatings (e.g., up to 50 weight percent of a radiation curable coating with less than 50 weight percent of a non-radiation curable coating) can also be employed as intermediate coating materials. If desired, two or more layers of different intermediate coatings can be employed in laminate finishes of the invention, in order to optimize properties such as adhesion to the substrate or to the overcoat, wear resistance, strippability, etc.

A variety of waterborne overcoat materials can be used in the invention. Suitable overcoat materials should be less strippable than the intermediate coating, and should be permeable by a chemical strip agent that is capable of stripping the intermediate coating material. Thus, the choice of overcoat material will be determined in part by the chosen intermediate coating material and stripping agent. Preferred overcoat materials will have a rating of 5 or less, and more preferably a rating of 3 or less, if coated alone on a vinyl composite tile substrate, allowed to dry or otherwise harden, and evaluated using the second Strippability Evaluation Method (7 point scale), Test Strip Agent K and a 10 minute strip agent standing time. When the intermediate coating and overcoat are each coated alone and compared using such an evaluation method, they preferably will have at least a 1 point differential, more preferably at least a 2 point differential, and most preferably at least a 4 point differential in observed strippability rating values.

Polymerizable overcoat materials (e.g. two-part thermally curable or one-part photocurable materials) are preferred due to their durability. Preferably the overcoat is not metal crosslinked. Suitable overcoat materials include urethanes, acrylics, epoxies, melamines and blends or copolymers thereof. Waterborne UV curable acrylates and urethanes are particularly preferred overcoat materials. These tend to be less strippable and more wear resistant than the metal crosslinked acrylic intermediate coatings mentioned above, and are permeable by strip agents that can be used to remove such intermediate coating materials. Suitable commercially or experimentally available waterborne overcoat materials include UV curable acrylates, urethanes and urethane acrylates (including aliphatic polyester urethane acrylates) such as UV curable coatings from UV Coatings Limited; ULTRA BRITE II™ V curable coating from Minuteman, International, Inc.; the above-mentioned ROSHIELD™ 3120 UV curable acrylated latex; NEORAD™ NR-3709 UV curable aliphatic urethane coating from Zeneca Resins, and materials such as those described in U.S. Pat. Nos. 5,453,451 and 5,773,487. A variety of other coating resins that can be cured using suitable crosslinking agents, thermal initiators or photoinitiators can be employed, including COURTMASTER II™ waterborne acrylic urethane, available from Ecolab, Inc.; LAROMER™ PE 55W polyester acrylate, LR 8895 polyester acrylate, LR 8949 aliphatic urethane and LR 8983 aromatic urethane waterborne acrylic ester resins, all available from BASF Corp.; VIAKTIN™ VTE 6155 aliphatic urethane acrylate, VTE 6165 aromatic urethane acrylate and VTE 6169 aliphatic polyester urethane radiation curing resins, all available from Solutia Inc.; 98-283W urethane acrylate, available from Hans Rahn & Co.; and materials such as those described in U.S. Pat. No 5,830,937. If desired, two or more layers of different overcoats can be employed in laminate finishes of the invention, in order to optimize properties such as adhesion to the intermediate coating, laminate surface appearance or properties, wear resistance, strippability, etc.

Suitable strip agents include compositions containing phenyl alcohols (e.g., benzyl alcohol); glycol ethers (e.g., propylene glycol methyl ether; phenoxy ethanol; phenoxy propanol; and Ethyl Carbitol™, Butyl Carbitol™ and Butyl Cellosolve™, all available from Union Carbide Corp.); metasilicates; alkanolamines (e.g., monoethanolamine); and caustic agents such as sodium or potassium hydroxide. Compositions containing phenyl alcohols are preferred for laminate finishes employing acrylate or urethane overcoats owing to the relatively high rate at which phenyl alcohols penetrate such overcoats and their ease of use and low odor.

A particularly preferred strip agent concentrate contains a polar solvent that is denser than water, and a sufficiently low level of cosolvent or surfactant so that upon mixing with water a pseudo-stable aqueous dispersion forms which will phase-separate following application to a surface. Concentrates of this type are described in copending application Ser. No. 09/641,775 filed Aug. 18, 2000, the disclosure of which is incorporated by reference.

Another preferred strip agent concentrate contains about 1 to 75 wt. percent of an ether alcohol solvent having a solubility in water of less than about 5 wt. % of the solvent, and about 1 to 75 wt. % of an ether alcohol solvent/coupler having a solubility in water of about 20 to about 100 wt. % of the solvent/coupler, wherein the vapor pressure of the concentrate is less than 1 millimeter Hg. Concentrates of this type are described in copending application Ser. No. 09/383,000 filed Aug. 25, 1999, the disclosure of which is incorporated by reference.

Suitable commercially available strip agents include HAWK™, FREEDOM™ and CARE STRIP LOW ODOR™ stripper concentrates from Ecolab, Inc.; JUGGERNAUT™ stripper concentrate from Buckeye International, Inc. and TWIST AND FILL™ stripper concentrate from 3M. Although no longer commercially available, an aqueous stripper concentrate previously sold in Canada as FULLER FORMULA 3100™ Super Concentrate (Fuller Brush, Quebec) can also be used in the present invention.

The intermediate coating, overcoat and strip agent can contain a variety of adjuvants to alter the performance of properties of each component before or after application to a substrate. Useful adjuvants include leveling agents and other surface-active agents, defoamers, solvents to accelerate or to slow the drying rate, waxes, fillers, indicators and colorants. They types and amounts of such adjuvants will be apparent to those skilled in the art.

The compositions of the invention can be applied using a variety of methods, including spraying, brushing, roll coating and flood coating. Mop application is preferred for coating floors. Typically the substrate should first be cleaned and any loose debris removed. One or more coats of the intermediate coating (diluted if necessary with water or another suitable solvent) are applied to the substrate, and allowed to dry. Three to five coats of the intermediate coating typically will be preferred for coating floors. When used on floors, each coat of the intermediate coating preferably will have a dry coating thickness of about 2.5 to about 75 micrometers, more preferably about 2.5 to about 20 micrometers, and the overall intermediate dry coating thickness preferably will be about 5 to about 38 micrometers, more preferably about 5 to about 20 micrometers.

Next, one or more coats of the waterborne overcoat (diluted if necessary with additional water or another suitable cosolvent) can be applied to the intermediate coating as soon as the intermediate coating has dried to the touch. The overcoat is applied, and cured or otherwise allowed to dry. One to five coats of the overcoat typically will be preferred for coating floors. When used on floors, each coat of the overcoat preferably will have a dry coating thickness of about 2.5 to about 75 micrometers, more preferably about 2.5 to about 20 micrometers, and the overall overcoat dry coating thickness preferably will be about 5 to about 38 micrometers, more preferably about 5 to about 20 micrometers. When used on floors, the laminate finish preferably will have an overall dry coating thickness of about 10 to about 75 micrometers, more preferably about 12 to about 38 micrometers.

The laminate finish composition can thereafter receive normal maintenance until such time as it is desired to remove and renew the laminate finish. The laminate finish can be stripped by optionally abrading the overcoat with a suitably mild abrasive (e.g., a green or black Scotch-Brite™ Floor Maintenance pad from 3M) and then applying a coating of the desired strip agent. The strip agent should be allowed to stand for a suitable time (e.g., for a minute or more, and typically between about 5 and about 30 minutes) while it permeates through the overcoat and attacks the intermediate coating. After the finish softens sufficiently, it can be removed using a variety of techniques including vacuuming, mopping or wiping. Removal will usually be made easier if water or a suitable detergent solution is applied to the softened finish. The substrate can be allowed to dry and new layers of the intermediate coat and overcoat can be applied to renew the laminate finish.

The compositions of the invention typically will be sold in the form of a kit containing the intermediate coating and overcoat in containers (e.g., separate containers) together with suitable directions for carrying out the methods of the invention. If desired, the intermediate coating or overcoat could be packaged as a concentrate intended to be mixed with water or another suitable diluting solvent at about a 15-40% solids level. Optionally the kit will include a container of the strip agent. The strip agent typically will be mixed with water or another suitable solvent at about a 5-30% by weight. The kit can also contain undercoat materials (e.g., leveling coatings) that can be applied to the substrate before application of the intermediate coating, and overcoat materials (e.g., wax finishes) that can be applied atop the overcoat.

The invention is further illustrated in the following non-limiting examples, in which all parts and percentages are by weight unless otherwise indicated. In the examples the following procedures were employed:

### Substrate Coating Procedure

A set of 150 mm square white or black vinyl composite floor tiles from Armstrong Tile or from American Biltrite Limited were coated with 2 coats of a waterborne metal-catalyzed acrylic floor finish (GEMSTAR LASER™, Ecolab Inc.) applied at a 20% solids level. Tiles coated only with this acrylic floor finish can readily be stripped in less than 30 minutes using all of the Test Strip Agents listed below. Each coat was allowed to air dry before application of the second coat. The total coating thickness after the second coat had dried was about 10 micrometers (at 5 micrometers per coat). This first set of coated tiles and a second set of uncoated tiles were next coated with various waterborne UV curable coating formulations. The UV curable coating formulations were applied at a 30% solids level with each coat being allowed to air dry before application of the next coat. Two coats of the UV curable coating formulation were applied to each of the metal-catalyzed acrylic floor finish coated tiles in the first set. The total dried coating thickness for these two UV curable coats was about 15 micrometers (at 7.5 micrometers per coat), yielding a combined coating thickness of about 25 micrometers. Three coats of the UV curable coating formulation were applied to each of the uncoated tiles in the second set. The total dried coating thickness for these three UV curable coats was about 22.5 micrometers (at 7.5 micrometers per coat). Thus the two sets of tiles were coated to nearly similar overall thicknesses, at 25 micrometers for the tiles in the first set and 22.5 micrometers thickness for the tiles in the second set. Both sets of tiles were passed through a UV curing apparatus containing an H bulb mercury vapor lamp operated at 1935 joule/sec per cm² and 4.9 meters per minute.

Test Strip Agents
Aqueous solutions of the following Test Strip
Agents diluted with deionized water were
used in the examples:

| | |
|---|---|
| Test Strip Agent A: | Concentrate¹ at 1:9 dilution (10% in water) |
| Test Strip Agent B: | Concentrate² at 1:9 dilution (10% in water); |
| | formed a clear solution |
| Test Strip Agent C: | Concentrate² at 1:4 dilution (20% in water); |
| | formed a cloudy solution |
| Test Strip Agent D: | Concentrate³ at 1:9 dilution (10% in water) |
| Test Strip Agent E: | Concentrate³ at 1:4 dilution (20% in water) |
| Test Strip Agent F: | Concentrate⁴ at 1:9 dilution (10% in water) |
| Test Strip Agent G: | Concentrate⁴ at 1:5 dilution (20% in water) |
| Test Strip Agent H: | Concentrate⁵ at 1:9 dilution (10% in water) |
| Test Strip Agent I: | Concentrate⁵ at 1:4 dilution (20% in water) |
| Test Strip Agent J: | Concentrate¹ at 1:4 dilution (20% in water) |
| Test Strip Agent K: | Dilute solution⁶ |
| Test Strip Agent L: | Concentrate⁷ at 1:4 dilution (20% in water) |

¹Concentrate containing 30 wt. % diethylene glycol monobutyl ether, 30 wt. % dipropylene glycol N-butyl ether, 30 wt. % propylene glycol phenyl ether and 10 wt. % “SURFONIC ™ 24-9” ethoxylated alcohol (Huntsman Chemical).
²Concentrate containing 49% benzyl alcohol, 17% monoethanolamine, 24% water and 10% sodium decyldiphenyl ether disulfonate.
³JUGGERNAUT ™ stripper concentrate from Buckeye International, Inc.
⁴Concentrate containing 44% benzyl alcohol, 32% monoethanolamine, 10% decanoic fatty acid, 11% octanoic fatty acid, 2% water and <1% DEQUEST ™ 2010 hydroxyethylidene diphosphonic acid (Solutia Inc.).
⁵Concentrate containing 75 wt. % benzyl alcohol, 7.5 wt. % diethylene glycol monobutyl ether, 7.5 wt. % dipropylene glycol N-butyl ether, 7.5 wt. % propylene glycol phenyl ether and 2.5 wt. % “SURFONIC 24-9” ethoxylated alcohol (Huntsman Chemical).
⁶Dilute solution made at a 1:3 dilution (25% in water) from a concentrate containing 59% softened water, 6% sodium xylene sulfonate, 4.5% potassium hydroxide, 10% monoethanolamine, 0.2% tetrasodium EDTA, 10% ethylene glycol phenyl ether and 0.05% fluorosurfactant (FC-129, 3M).
⁷Concentrate containing 48.5% benzyl alcohol, 40.75% monoethanolamine, 10.1% dinonylphenol ethoxylate (with an average of 10 EO units), and 0.15% “FC-120” fluorinated wetting agent (3M)

### First Strippability Evaluation Method (6 Point Scale)

Coated tiles were placed on a level surface and flooded with a sufficient quantity of a 10% aqueous solution of Test Strip Agent A to form a 50 mm diameter circular pool on the surface of each coated tile. The Test Strip Agent solution was allowed to remain on the tiles for approximately 20 minutes. Using light and consistent pressure, a nonwoven abrasive scrub pad (Scotch-Brite™ green abrasive, 3M) was used make 10 circular rubs on each tile. The tiles were rinsed with tap water, blotted dry and rated according to the following scale:

1) No effect

2) Chemical attack on surface (non tacky)

3) Slight removal in spots or abrasion (random scratches on the surface of the coating)

4) Incomplete strip (may strip completely in some areas, especially where overcoat was porous, but not in other areas. Coating is slightly soft or tacky)

5) Partial strip with softened coating in all areas

6) Complete strip

### Second Strippability Evaluation Method (7 Point Scale)

A 50 mm diameter by 38 mm high carbon steel cylinder with a weight of 571 grams was wrapped with a green nonwoven pad (Scotch-Brite™ Floor Maintenance Disc, 3M). When rolled over a coated tile substrate, the cylinder exerted a pressure of 2.8 kPa and mimicked the pressure applied by a standard electric floor burnisher. The coated tiles were placed on a level surface and flooded with a sufficient quantity of a 15% aqueous solution of various Test Strip Agents to form a 50 mm diameter circular pool on the surface of the coated tiles. The Strip Agent solution was allowed to remain on the coated tiles for 10 minute or 20 minute standing times. The cylinder was then rolled 10 times over each tile. The tiles were rinsed with tap water, blotted dry and rated according to the following scale:

1) No effect

2) Minimal chemical attack on coating

3) Moderate chemical attack on coating

4) Severe chemical attack on coating with onset of stripping

5) Incomplete strip (may strip completely in some areas, especially where coating was porous, but not in other areas. Finish is slightly soft or tacky)

6) Partial strip with softened finish in all areas

7) Complete strip

### EXAMPLE 1

Using the First Strippability Evaluation Method (6 Point Scale) set out above, several waterborne UV curable coating formulations obtained from UV Coatings Limited were applied to tiles and evaluated for strippability with and without the use of a strippable intermediate coating composition between the tile and the overcoat. The results are set out below in Table 1.

TABLE 1

| | Intermediate | | 6 Point Scale |
|---|---|---|---|
| Run No. | coating? | Overcoat | Evaluation |
| 1-1 | No | 935-62 | 1 |
| 1-2 | Yes | 935-62 | 3 |
| 1-3 | No | 935-63 | 1 |
| 1-4 | Yes | 935-63 | 4 |
| 1-5 | No | 935-64 | 3 |
| 1-6 | Yes | 935-64 | 5 |
| 1-7 | No | 935-65 | 4 |
| 1-8 | Yes | 935-65 | 5 |
| 1-9 | Yes | 935-65¹ | 5 |

¹Modified by the addition of 0.07% FC-120 fluorinated surfactant, 3M

The results in Table 1 show that for each of the tested UV curable overcoat formulations, strippability was improved when the intermediate coat was present.

### EXAMPLE 2

Using the method of Example 1, a waterborne UV curable coating formulation obtained from UV Coatings Limited (identified as “936-66-2”, a 75:25 blend of an aliphatic polyester urethane and an acrylic resin) was applied as an overcoat to vinyl composite tiles, with and without a strippable intermediate coating composition between the tile and the overcoat. Using the Second Strippability Evaluation Method (7 Point Scale), the coatings were evaluated for strippability. Test Strip Agents B and C were employed for 10 minute or 30 minute standing times. The results are set out below in Table 2.

TABLE 2

| | Intermediate | Test Strip | Standing | 7 Point Scale |
|---|---|---|---|---|
| Run No. | coating? | Agent | Time, min | Evaluation |
| 2-1 | No | B | 10 | 2 |
| 2-2 | Yes | B | 10 | 7 |
| 2-3 | No | B | 30 | 3 |
| 2-4 | Yes | B | 30 | 7 |
| 2-5 | No | C | 10 | 5 |
| 2-6 | Yes | C | 10 | 7 |
| 2-7 | No | C | 30 | 4 |
| 2-8 | Yes | C | 30 | 7 |
| 2-9 | No | D | 10 | 1 |
| 2-10 | Yes | D | 10 | 1 |
| 2-11 | No | D | 30 | 1 |
| 2-12 | Yes | D | 30 | 5 |
| 2-13 | No | E | 10 | 1 |
| 2-14 | Yes | E | 10 | 2 |
| 2-15 | No | E | 30 | 1 |
| 2-16 | Yes | E | 30 | 7 |
| 2-17 | No | F | 10 | 2 |
| 2-18 | Yes | F | 10 | 6 |
| 2-19 | No | F | 30 | 2 |
| 2-20 | Yes | F | 30 | 7 |
| 2-21 | No | G | 10 | 3 |
| 2-22 | Yes | G | 10 | 6 |
| 2-23 | No | G | 30 | 3 |
| 2-24 | Yes | G | 30 | 7 |
| 2-25 | No | H | 10 | 4 |
| 2-26 | Yes | H | 10 | 6 |
| 2-27 | No | H | 30 | 4 |
| 2-28 | Yes | H | 30 | 7 |
| 2-29 | No | I | 10 | 4 |
| 2-30 | Yes | I | 10 | 6 |
| 2-31 | No | I | 30 | 4 |
| 2-32 | Yes | I | 30 | 7 |
| 2-33 | No | A | 10 | 1 |
| 2-34 | Yes | A | 10 | 1 |
| 2-35 | No | A | 30 | 1 |
| 2-36 | Yes | A | 30 | 2 |
| 2-37 | No | J | 10 | 1 |
| 2-38 | Yes | J | 10 | 1 |
| 2-39 | No | J | 30 | 1 |
| 2-40 | Yes | J | 30 | 4 |

The results in Table 2 show that for each of the tested UV curable overcoat formulations, strippability was improved when the intermediate coat was present. The laminate finish formulations were completely strippable with most of the Test Strip Agents, whereas the corresponding overcoat was not completely strippable with any of the Test Strip Agents. Complete stripping of the laminate finish formulations was achieved in less than 6 minutes using Test Strip Agent B, and in less than 1 minute using Test Strip Agent C.

### EXAMPLE 3

Two waterborne TV curable coating formulations were prepared from the ingredients set out below in Table 3-1:

TABLE 3-1

| | Formulation | Formulation |
|---|---|---|
| Ingredient | A, Parts | B, Parts |
| VIAKTIN ™ VTE 6165 resin¹ | 42.86 | |
| VIAKTIN ™ VTE 6169 resin² | | 42.86 |
| Irgacure 500 photoinitiator³ | 1.57 | 1.57 |
| Wax 325 polymer emulsion⁴ | 1.05 | 0.53 |
| Wax 43N polymer emulsion⁴ | 1.05 | 1.58 |
| PI-35 defoamer⁵ | 0.1 | 0.1 |
| FC-120 fluorosurfactant⁶ | 0.05 | 0.05 |
| Deionized water | 53.32 | 53.32 |

¹Aromatic urethane acrylate radiation curing resin, available from Solutia Inc.
²Aliphatic polyester urethane radiation curing resins, available from Solutia Inc.
³Available from Ciba-Geigy Company
⁴Available from Emulsion Systems, Inc.
⁵Available from Ultra Additives, Inc.
⁶Available from 3M

Using the method of Example 1, these compositions were applied as overcoats to vinyl composite tiles, with and without a strippable intermediate coating composition between the tile and the overcoat. Using the Second Strippability Evaluation Method (7 Point Scale), the coatings were evaluated for strippability. Test Strip Agent L was employed for a 10 minute standing time. The results are set out below in Table 3-2.

TABLE 3-2

| | Intermediate | | | 7 Point Scale |
|---|---|---|---|---|
| Run No. | coating? | Overcoat | Test Strip Agent | Evaluation |
| 3-1 | No | A | L | 2 |
| 3-2 | Yes | A | L | 7 |
| 3-3 | No | B | L | 2 |
| 3-4 | Yes | B | L | 7 |

### EXAMPLE 4

A waterborne UV curable coating formulation was prepared from the ingredients set out below in Table 4-1 and identified as Formulation C:

TABLE 4-1

| | Formulation C, |
|---|---|
| Ingredient | Parts |
| VIAKTIN ™ VTE 6165 resin | 52.00 |
| KLEBOSOL ™ 30N25 silica sol¹ | 10.00 |
| ETHYL CARBITOL ™² | 6.30 |
| IRGACURE ™ 500 photoinitiator | 2.60 |
| Wax 43N polymer emulsion | 1.91 |
| Wax 325 polymer emulsion | 0.64 |
| ZONYL ™ FSJ fluorosurfactant, 10%³ | 0.45 |
| PI-35 defoamer | 0.15 |
| Deionized water | 25.95 |

¹Available from Clariant Corp.
²Available from Union Carbide Corp.
³Available from E. I. duPont de Nemours and Co.

Using the method of Example 1, a 3.5 g layer of Formulation C was applied as an overcoat to vinyl composite tiles coated with an intermediate coating of GEMSTAR LASER floor finish according to the Substrate Coating Procedure. 3.5 g layers of Formulation C were also applied as overcoats to vinyl composite tiles coated according to the same Substrate Coating Procedure, but using an intermediate coating of PADLOCK™ floor finish (Ecolab) or TOPLINE™ floor finish (3M) in place of the GEMSTAR LASER intermediate coating. The resulting laminate finishes were evaluated for intercoat adhesion using the method of Examples 72-80 of PCT Published Application No. WO 98/11168. In this method, cuts are made with a razor blade through the cured laminate finish and into the tile substrate to form a grid of 0.32 cm×0.32 cm squares. A piece of SCOTCH™ Rug and Carpet Tape (3M) is applied onto the square pattern using a 2.3 kg roller. The tape is peeled by hand from the tile by grabbing an end of the tape and pulling the tape back over itself at about a 180° angle. Adhesion is determined by visual inspection of both the tile and the removed tape to determine the percentage of the square sections removed from the tile. A value of 0% adhesion means all of the coating is removed from the tile while a value of 100% adhesion means none of the coating is removed.

All of the laminate finishes exhibited 100% adhesion (0% of the squares were removed). Thus the use of a waterborne radiation-curable coating provided good adhesion to intermediate coatings made from three conventional floor finishes, without the need for inclusion of free-radically polyrnerizable groups in the intermediate coating.

In contrast, in Examples 74-75 of PCT Published Application No. WO 98/11168 a solvent-borne UV curable coating provided 0% adhesion to TECHNIQUE™ (SC Johnson Professional Products) and TOPLINE floor finishes, and only provided 100% adhesion when an acrylated latex (ROSHIELD™ 3120, Rohm & Haas) was employed as a primer between the tile and the UV curable coating.

A separate and more stringent adhesion test was performed on the laminate finishes as follows. This test employed a Gardner Adhesion Test Kit PA 2000 (Byk Gardner USA) and a PA-2056 blade (6 teeth/2.0 mm). Cuts are made with the blade through the cured laminate finish and into the tile substrate to form a 7×7 grid containing 49 squares. A piece of No. 600 Transparent Tape (3M) is applied onto the square pattern and rubbed vigorously to adhere the tape strongly to the coating. The tape is rapidly peeled by hand from the tile, and number of squares exhibiting coating delamination is divided by the total number of squares to determine the percent adhesion loss. The laminate finishes employing PADLOCK floor finish as a primer exhibited 100% adhesion (0% of the squares were removed). Laminate finishes employing TOPLINE floor finish as a primer exhibited 89% adhesion (11% of the squares were removed). Laminate finishes employing GEMSTAR floor finish as a primer exhibited 78% adhesion (22% of the squares were removed). These adhesion results indicate that the laminate finishes would be very resistant to delamination.

### EXAMPLE 5

A stripper composition was prepared by combining 75 wt. % benzyl alcohol, 7.5 wt. % diethylene glycol monobutyl ether, 7.5 wt. % dipropylene glycol N-butyl ether, 7.5 wt. % propylene glycol phenyl ether and 2.5 wt. % SURFONIC™ 24-9 ethoxylated alcohol (Huntsman Chemical) to form a concentrate, and combining 10 parts of the resulting concentrate with 3 parts monoethanolamine, 0.15 parts ZONYL™ FSJ fluorosurfactant (commercially available from E. I. duPont de Nemours and Co.) and 87 parts water. The resulting diluted stripper composition forms a pseudo-stable aqueous dispersion when stirred. Shortly after application of the diluted stripper composition to a surface, the composition undergoes phase separation to form a solvent layer containing primarily benzyl alcohol adjacent to the surface with a layer containing primarily water atop the solvent layer. The diluted stripper composition was identified as “Test Strip Agent M”.

Two 150 mm square uncoated black vinyl composite floor tiles from Armstrong Tile were scratched with a nonwoven abrasive scrub pad (SCOTCH-BRITE™ green abrasive, 3M) until the tile surface was no longer shiny. A single thick coat containing 3.5 g of PADLOCK floor finish was applied to one of the scratched tiles at a 31% solids level and allowed to air dry to form a strippable intermediate coating. The coated tile was placed in an oven for 15 minutes at 60° C. to insure that the intermediate coating was dry. Tiles coated only with this acrylic floor finish can readily be completely stripped (yielding a strippability rating of 7) in less than 10 minutes using Test Strip Agent M.

The uncoated and intermediate layer-coated tiles were next coated with a single thick overcoat containing 6 g of ULTRA BRITE II™ UV curable coating (Minuteman, Inc.) The tiles were passed through a UV curing apparatus at 6.1 meters per minute. The apparatus contained an H bulb mercury vapor lamp that provided UVA, UVB, UVC and UVV energy dosages of 0.2, 0.17, 0.02 and 0.08 J/cm², respectively as measured using a UV Power Puck™ (EIT Inc.).

Using the Second Strippability Evaluation Method (7 Point Scale), Test Strip Agent M and a 30 minute strip agent standing time, the coated tiles were evaluated for strippability. The results are set out below in Table 5-1.

TABLE 5-1

| | Intermediate | | | 7 Point Scale |
|---|---|---|---|---|
| Run No. | coating? | Overcoat | Test Strip Agent | Evaluation |
| 5-1 | No | ULTRA | M | 2 |
| | | BRITE II | | |
| 5-2 | Yes | ULTRA | M | 6 |
| | | BRITE II | | |

The ULTRA BRITE II UV coating system was introduced in the US some time on or after Jul. 31, 2000, for use on tile and terrazzo floors. As shown in Table 5-1, if the UV curable coating is applied directly to vinyl tile (as is recommended by the manufacturer), a strip agent provides only minimal chemical attack on the cured coating, and the coating can not readily be removed by stripping. However, if the UV curable coating is applied atop an intermediate coating, strippability is greatly improved.

Various modifications and alterations of this invention will be apparent to those skilled in the art without departing from the scope and spirit of this invention. It should be understood that this invention is not limited to the illustrative embodiments set forth above.

1. A coated substrate comprising a strippable intermediate coating atop the substrate and a strip agent-permeable two-part overcoat adhered to the intermediate coating, wherein the dried overcoat is less strippable and more wear-resistant than the dried intermediate coating.

2. A coated substrate according to claim 1, wherein the substrate comprises a floor.

3. A coated substrate according to claim 2, wherein the substrate comprises a resilient flooring material.

4. A coated substrate according to claim 3, wherein the substrate comprises a vinyl or vinyl composite tile.

5. A coated substrate according to claim 1, wherein the substrate comprises a wall, ceiling, label, emblem, sign or vehicle.

6. A coated substrate according to claim 1, wherein the intermediate coating comprises a metal-catalyzed acrylic.

7. A coated substrate according to claim 1, wherein the intermediate coating has a strippability rating of 6 or more on a 7 point scale, corresponding to at least partial strip with softened coating in all areas, using a test strip agent made using a 25% water solution of a concentrate that contained 59% softened water, 6% sodium xylene sulfonate, 4.5% potassium hydroxide, 10% monoethanolamine, 0.2% tetrasodium EDTA, 10% ethylene glycol phenyl ether and 0.05% fluorosurfactant, and a 10 minute standing time.

8. A coated substrate according to claim 1, wherein the intermediate coating has a thickness of about 2.5 to about 75 micrometers.

9. A coated substrate according to claim 1, wherein the overcoat comprises an emulsion, suspension or dispersion.

10. A coated substrate according to claim 1, wherein the overcoat is radiation curable.

11. A coated substrate according to claim 1, wherein the overcoat is UV-curable.

12. A coated substrate according to claim 1, wherein the overcoat comprises an acrylate, urethane or acrylated urethane.

13. A coated substrate according to claim 12, wherein the overcoat comprises an aromatic urethane.

14. A coated substrate according to claim 12, wherein the overcoat comprises an aliphatic polyester urethane.

15. A coated substrate according to claim 1, wherein the overcoat is not metal crosslinked.

16. A coated substrate according to claim 1, wherein the dried overcoat has a strippability rating of 4 or less on a 7 point scale, corresponding to no more than severe chemical attack on the overcoat and the onset of stripping, using a test strip agent made using a 25% water solution of a concentrate that contained 59% softened water, 6% sodium xylene sulfonate, 4.5% potassium hydroxide, 10% monoethanolamine, 0.2% tetrasodium EDTA, 10% ethylene glycol phenyl ether and 0.05% fluorosurfactant, and a 30 minute standing time.

17. A coated substrate according to claim 1, wherein the dried overcoat has a thickness of about 2.5 to about 75 micrometers.

18. A coated substrate according to claim 1, wherein the overcoat comprises two or more different layers of materials.

19. A coated substrate according to claim 1, wherein the substrate comprises a floor and the overcoat is UV curable.

20. A strippable laminate finish kit, comprising one or more containers of a strippable intermediate coating and a strip agent-permeable two-part overcoat, wherein the dried overcoat adheres to the intermediate coating and is less strippable and more wear resistant than the dried intermediate coating.

21. A strippable laminate finish kit according to claim 20, further comprising a strip agent.

22. A strippable laminate finish kit according to claim 20, wherein the overcoat comprises a one-part photopolymerizable material.

23. A strippable laminate finish kit according to claim 20, wherein the overcoat comprises a UV curable material.

24. A strippable laminate finish kit according to claim 20, wherein the overcoat comprises an acrylate, urethane or acrylated urethane.

25. A strippable laminate finish kit according to claim 20, wherein the overcoat comprises an aromatic urethane.

26. A strippable laminate finish kit according to claim 20, wherein the overcoat comprises an aliphatic polyester urethane.

27. A strippable laminate finish kit according to claim 20, wherein:
a) the intermediate coating has a strippability rating of 6 or more on a 7 point scale, corresponding to at least partial strip with softened coating in all areas, and
b) the overcoat has a strippability rating of 4 or less on a 7 point scale, corresponding to no more than severe chemical attack on the overcoat and the onset of stripping, using a test strip agent made using a 25% water solution of a concentrate that contained 59% softened water, 6% sodium xylene sulfonate, 4.5% potassium hydroxide, 10% monoethanolamine, 0.2% tetrasodium EDTA, 10% ethylene glycol phenyl ether and 0.05% fluorosurfactant, and a 10 minute standing time.

28-35 cancelled.

36. A coated substrate according to claim 1, wherein the overcoat comprises a urethane.

37. A strippable laminate finish kit according to claim 20, wherein the overcoat comprises a urethane.
